(19) United States
(12) Patent Application Publication
(10) Pub. No.: US 2011/0151805 A1
(43) Pub. Date: Jun. 23, 2011

(54) COUPLER AND WIRELESS COMMUNICATION DEVICE USING COUPLER

(75) Inventors: Kouji Hayashi, Tokyo (JP); Hiroyuki Hotta, Tokyo (JP)

(73) Assignee: KABUSHIKI KAISHA TOSHIBA, Tokyo (JP)

(21) Appl. No.: 12/787,542

(22) Filed: May 26, 2010

(30) Foreign Application Priority Data
Dec. 21, 2009 (JP) P2009-289631

(51) Int. Cl. H04B 1/40; H01P 5/00

(52) U.S. Cl. 455/84; 333/24 R

(57) ABSTRACT

A coupler which is connectable to a feeder circuit of a wireless communication device is provided. The coupler includes a conductive element, a short circuit portion, a feeder portion and grounded plate. The conductive element has a substantially plane face. The short circuit portion is provided to the conductive element. The short circuit portion is positioned closer to a geometric gravity center of the conductive element than to an outer fringe of the face of the conductive element. The feeder portion is provided to the conductive element. The feeder portion is positioned separately from the short circuit portion. The feeder portion electrically connects the conductive element to the feeder circuit. The grounded plate is short-circuited to the conductive element via the short circuit portion.

### CROSS REFERENCE TO RELATED APPLICATIONS

This application is based upon and claims the benefit of priority from the prior Japanese Patent Application No. 2009-289631 filed on Dec. 21, 2009;

the entire contents of which are incorporated herein by reference.

### FIELD

The present invention relates to a radio frequency coupler for close-proximity wireless communication.

### BACKGROUND

Close-proximity wireless communication means of a shorter communication range than that of a short range wireless communication means such as Bluetooth (registered trademark) has been proposed in recent years. As one of such close-proximity wireless communication means, TransferJet (registered trademark) can be enumerated. TransferJet is a system which carries out communication by putting paired couplers for signal transmission and reception close to each other. TransferJet assumes a communication range of a few centimeters, and has various advantages on aspects of security, etc. TransferJet features a high transmission rate (up to a few hundreds of Mbps), and is suited to large-sized data transmission for multimedia content, etc.

An ordinary coupler of an electric field coupling type was disclosed. Such a coupler of an electric field coupling type has an electrode and a stub for impedance matching. In order to carry out wireless communication via this coupler, it is necessary to put a pair of the couplers as close as a couple of centimeters to each other. As radio waves do not go a long way, the system of the wireless communication via this coupler hardly causes interruption or interference to another system.

It is difficult to make the coupler of the electric field coupling type thin as it needs to be thick enough to be provided with a stub. Further, if the coupler is made thin, the gap between the stub and the electrode inevitably becomes small, so that the both are electromagnetically coupled with each other. The electromagnetic coupling degrades the performance of the coupler. Further, the coupler is likely to be large in external size as it is provided with the stub. The coupler which is too large in external size can possibly make a wireless communication device (e.g., a mobile phone) unable to contain the coupler.

### BRIEF DESCRIPTION OF THE DRAWINGS

FIG. 1 illustrates an exemplary coupler of a first embodiment.

FIG. 2 illustrates a series resonance mode of the coupler shown in FIG. 1.

FIG. 3 illustrates a parallel resonance mode of the coupler shown in FIG. 1.

FIGS. 4-7 illustrate four exemplary couplers of the first embodiment.

FIG. 5 illustrates an exemplary coupler of the first embodiment.

FIG. 6 illustrates an exemplary coupler of the first embodiment.

FIG. 7 illustrates an exemplary coupler of the first embodiment.

FIG. 8 is a graph for illustrating an S11 parameter of the coupler shown in FIG. 4.

FIG. 9 is a graph for illustrating an S11 parameter of the coupler shown in FIG. 5.

FIG. 10 is a graph for illustrating an S11 parameter of the coupler shown in FIG. 6.

FIG. 11 is a graph for illustrating an S11 parameter of the coupler shown in FIG. 7.

FIG. 12 conceptually illustrates a current distribution of the coupler shown in FIG. 1.

FIG. 13 illustrates rotation of the coupler.

FIGS. 14-22 illustrate eight exemplary couplers of the first embodiment.

FIG. 23 illustrates a coupler of a second embodiment.

FIG. 24 illustrates a coupler of a third embodiment.

FIG. 25 is a block diagram for illustrating a wireless communication device using the coupler of one of the respective embodiments.

### DETAILED DESCRIPTION

An advantage of an embodiment is to provide a coupler which is fit to be made light, thin, short and small, and shows good performance.

According to an embodiment, a coupler which is connectable to a feeder circuit of a wireless communication device is provided. The coupler includes a conductive element, a short circuit portion, a feeder portion and grounded plate. The conductive element has a substantially plane face. The short circuit portion is provided to the conductive element. The short circuit portion is positioned closer to a geometric gravity center of the conductive element than to an outer fringe of the face of the conductive element. The feeder portion is provided to the conductive element. The feeder portion is positioned separately from the short circuit portion. The feeder portion electrically connects the conductive element to the feeder circuit. The grounded plate is short-circuited to the conductive element via the short circuit portion.

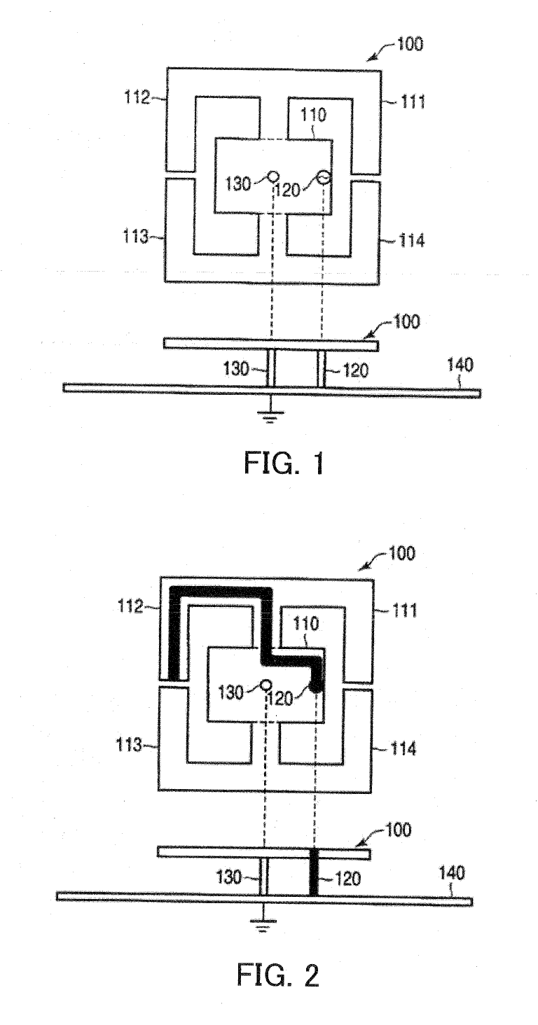

Embodiments of the present invention will be described with reference to the drawings. As shown in FIG. 1, a coupler 100 of a first embodiment of the present invention has a coupled electrode element 110, coupled elements 111-114, a feeder portion 120, a short-circuit portion 130 and a grounded plate 140. As explained below, the coupled electrode element 110 and the coupled elements 111-114 are called together a coupled electrode in some cases.

The coupled electrode element 110 is formed by an optional conductive element having a substantially plane face of a certain area. The coupled electrode element 110 can be polygonal, i.e., rectangular or else, or circular. Further, the coupled electrode element 110 can be linear as long as it can connect the coupled electrode and the grounded plate 140. The coupled electrode element 110 is provided near a geometric gravity center with the short-circuit portion 130 for short-circuiting the coupled electrode. Geometric gravity center positions of various shapes can be found out by means of a known method. The above phrase “near the geometric gravity center” can be understood to indicate an area separate from the gravity center by a separation which is lower than a wavelength of a carrier wave multiplied by a certain ratio (that can be empirically or experimentally known). The above phrase “near the geometric gravity center” can be understood to indicate an area which is closer to the gravity center than to an outer fringe. Assume, for simplicity, that the position of the short-circuit portion 130 agrees with the geometric gravity center of the coupled electrode element 110 as explained below. The coupled electrode element 110 is provided with the feeder portion 120 for feeding the coupled electrode at a position separate from the short-circuit portion 130 by a certain separation. The separation between the short-circuit portion 130 and the feeder portion 120 will be described later from a technical viewpoint.

The grounded plate 140 is provided opposite the coupled electrode. In general, the grounded plate 140 is provided substantially parallel to the coupled electrode. In a case where the coupled electrode is formed not in 2D but in 3D (e.g., like a sphere), however, the grounded plate 140 is not necessarily provided substantially parallel to the coupled electrode. The grounded plate 140 is at least greater than the coupled electrode in size. If, e.g., the coupled electrode and the grounded plate 140 are both square, each side of the grounded plate 140 is longer than each side of the coupled electrode. Further, it is enough that the coupled electrode is sized so as to effectively work (the coupler 100 can be coupled to an opposite coupler). How large the coupled electrode is sized can be empirically or experimentally known.

The coupled elements 111-114 are formed, e.g., by the same conductive element as that of the coupled electrode element 110. The coupled element 111 shares a portion including one end with the coupled element 112, and the other ends of the coupled elements 111 and 112 are both open. The end portion shared by the coupled elements 111 and 112 is electrically connected to the outer fringe of the coupled electrode element 110. The coupled element 113 shares a portion including one end with the coupled element 114, and the other ends of the coupled elements 113 and 114 are both open. The end portion shared by the coupled elements 113 and 114 is electrically connected to the outer fringe of the coupled electrode element 110. As the coupled elements 111-114 are just conceptually distinguished from the coupled electrode element 110, however, a single conductive material can be processed so as to agree with an external shape of the coupled electrode (by printing a conductive pattern, scraping the conductive material, etc.), so that both the coupled elements 111-114 and the coupled electrode element 110 are formed together.

The coupled elements 111-114 are shaped symmetrically to one another. To put it specifically, the coupled elements 111 and 112 are line-symmetrical to each other with respect to an axis which passes the geometric gravity center of the coupled electrode element 110. Further, the coupled elements 111 and 113 are line-symmetrical to each other with respect to an axis which passes the geometric gravity center of the coupled electrode element. Further, the coupled elements 111 and 114 are point-symmetrical to each other with respect to the geometric gravity center of the coupled electrode element. As described later, however, the symmetrical shapes which the plural coupled elements form with one another are of just an exemplary configuration of the coupler of the embodiment. A path length from the other end (open end) of each of the coupled elements 111-114 to the short-circuit portion 130 substantially equals a quarter wavelength of the carrier wave multiplied by an odd number.

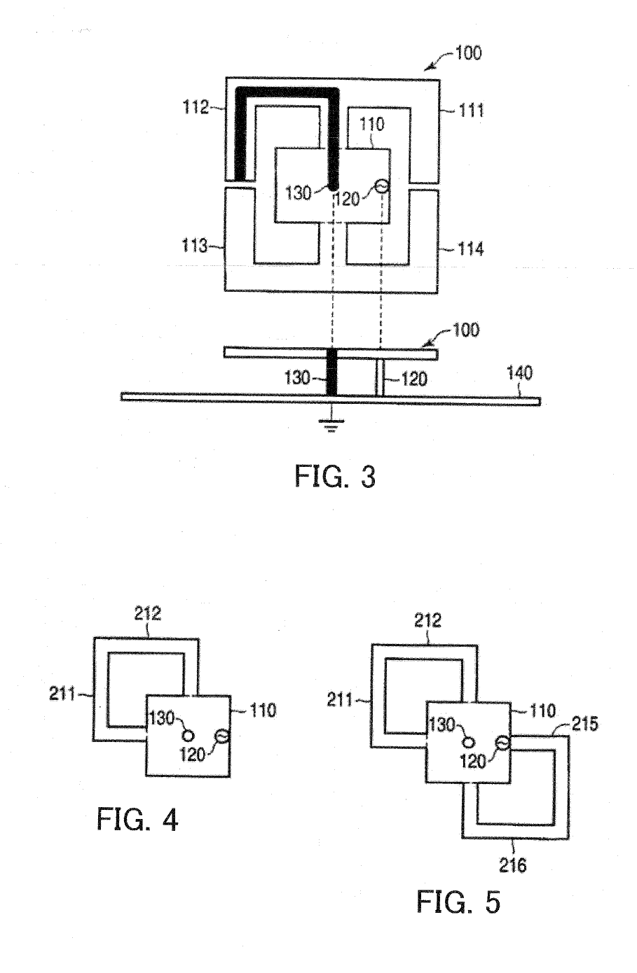

Then, resonance modes of the coupler 100 shown in FIG. 1 will be explained with reference to FIGS. 2 and 3. A current path covered with paint as shown in FIG. 2 exists from the feeder portion 120 to the other end of the coupled element 112. Similar current paths exist from the feeder portion 120 to the other ends (open ends) of the coupled elements 111, 113 and 114. The current path has a length which substantially equals the quarter wavelength of the carrier wave multiplied by an odd number. The coupler 100 is resonant at a frequency corresponding to the carrier wave. The current path corresponds to a series resonance mode.

A current path covered with paint as shown in FIG. 3 exists from the short-circuit portion 130 to the other end of the coupled element 112. Similar current paths exist from the short-circuit portion 130 to the other ends (open ends) of the coupled elements 111, 113 and 114. The current path has a length which substantially equals the quarter wavelength of the carrier wave multiplied by an odd number. The coupler 100 is resonant at a frequency corresponding to the carrier wave. The current path corresponds to a parallel resonance mode.

The coupler 100 can be regarded as a collection of a plurality of unit couplers sharing the feeder portion 120 and the short-circuit portion 130. For instance, the coupled element 111, a portion of the coupled electrode element 110, the feeder portion 120 and the short-circuit portion 130 form a first unit coupler. The coupled element 112, a portion of the coupled electrode element 110, the feeder portion 120 and the short-circuit portion 130 form a second unit coupler. The coupled element 113, a portion of the coupled electrode element 110, the feeder portion 120 and the short-circuit portion 130 form a third unit coupler. The coupled element 114, a portion of the coupled electrode element 110, the feeder portion 120 and the short-circuit portion 130 form a fourth unit coupler. Impedance of the coupler 100 can be adjusted dependently on a separation between the feeder portion 120 and the short-circuit portion 130. To put it specifically, in a case where a distance between the coupled electrode and the grounded plate 140 is reduced (i.e., the coupler 100 is made thin), it is preferable to put the feeder portion 120 close to the short-circuit portion 130 so as to prevent the impedance from decreasing. Further, e.g., one-tenth of the carrier wavelength can be set as an upper limit of the separation between the feeder portion 120 and the short-circuit portion 130. The value of one-tenth of the carrier wavelength is empirically known as an upper limit for effectively working the coupler 100.

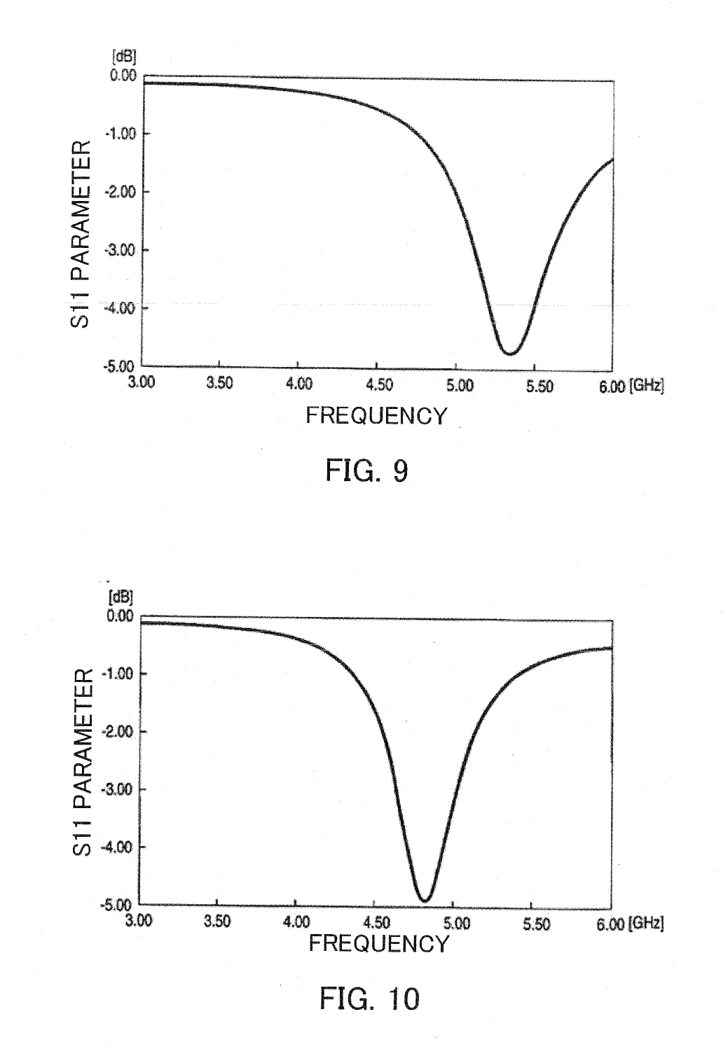

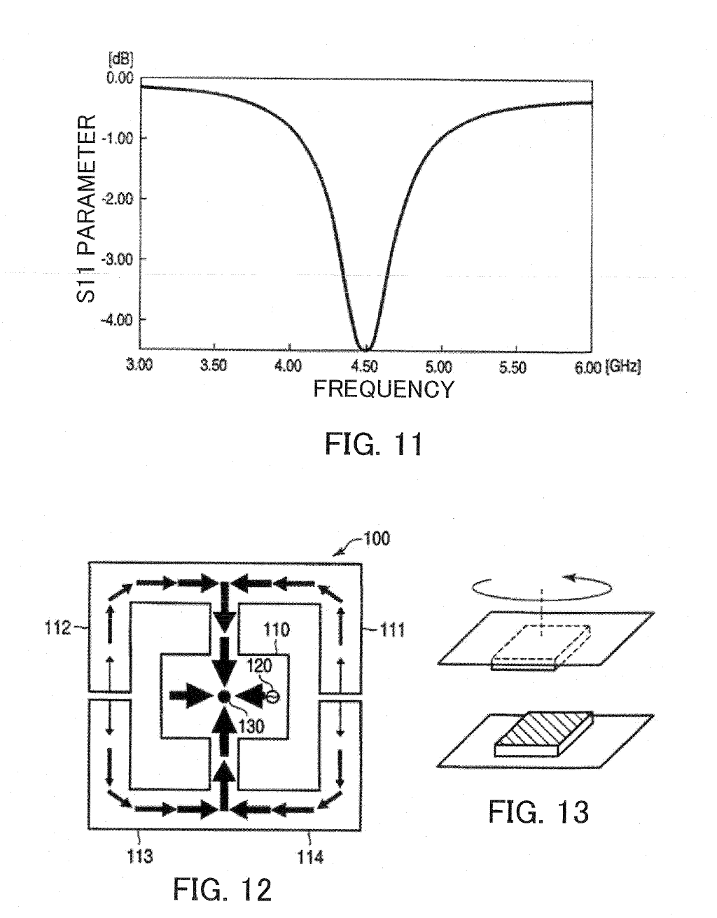

As described above, the impedance of the coupler 100 can be adjusted dependently on the separation between the feeder portion 120 and the short-circuit portion 130. Thus, as being in no need of a stub, the coupler 100 is fit to be made light, thin, short and small, and shows good performance. As described above, the coupler 100 has four coupled elements. The coupler of the embodiment, however, can have fewer or more than four coupled elements. S11 parameters in cases where the number of the coupled elements is two, four, six and eight will be explained below with reference to FIGS. 4-11.

FIG. 4 illustrates a coupler having two coupled elements 211 and 212. The coupled elements 211 and 212 are formed by, e.g., the same conductive element as that of the coupled electrode element 110. The one end of the coupled element 211 is electrically connected to the outer fringe of the coupled electrode element 110. The one end of the coupled element 212 is electrically connected to the outer fringe of the coupled electrode element 110. The other ends of the coupled elements 211 and 212 are electrically connected to each other. The coupled elements 211 and 212 are line-symmetrical to each other with respect to an axis which passes the geometric gravity center of the coupled electrode element 110. The coupler shown in FIG. 4 can be regarded as a collection of two unit couplers.

FIG. 5 illustrates a coupler formed by further addition of two coupled elements 215 and 216 to the example shown in FIG. 4. The coupled elements 215 and 216 are formed by, e.g., the same conductive element as that of the coupled electrode element 110. The one end of the coupled element 215 is electrically connected to the outer fringe of the coupled electrode element 110. The one end of the coupled element 216 is electrically connected to the outer fringe of the coupled electrode element 110. The other ends of the coupled elements 215 and 216 are electrically connected to each other. Further, the coupled elements 215 and 211 are point-symmetrical with respect to the geometric gravity center of the coupled electrode element 110. The coupled elements 216 and 212 are point-symmetrical with respect to the geometric gravity center of the coupled electrode element 110. The coupler shown in FIG. 5 can be regarded as a collection of four unit couplers.

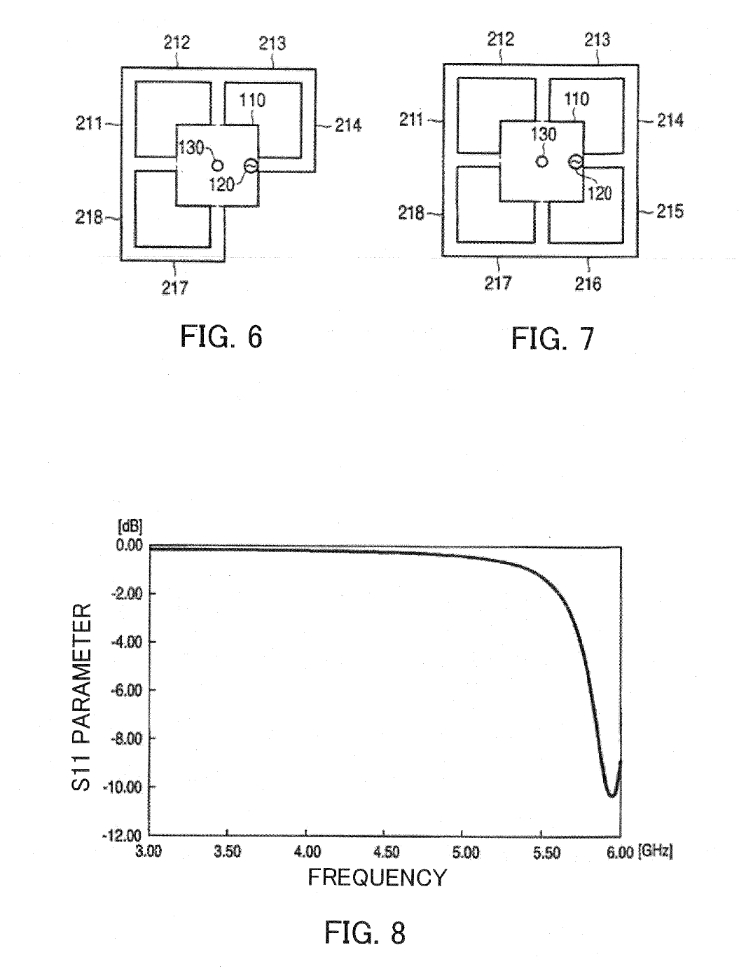

FIG. 6 illustrates a coupler formed by further addition of four coupled elements 213, 214, 217 and 218 to the example shown in FIG. 4. The coupled elements 213, 214, 217 and 218 are formed by, e.g., the same conductive element as that of the coupled electrode element 110. The coupled element 212 shares a portion including one end with the coupled element 213. The coupled element 211 shares a portion including one end with the coupled element 218. The one end of the coupled element 214 is electrically connected to the outer fringe of the coupled electrode element 110. The one end of the coupled element 217 is electrically connected to the outer fringe of the coupled electrode element 110. The other ends of the coupled elements 213 and 214 are electrically connected to each other. The other ends of the coupled elements 217 and 218 are electrically connected to each other. Further, the coupled elements 213 and 212 are line-symmetrical to each other with respect to an axis which passes the geometric gravity center of the coupled electrode element 110. The coupled elements 214 and 212 are point-symmetrical to each other with respect to the geometric gravity center of the coupled electrode element 110. The coupled elements 217 and 211 are point-symmetrical to each other with respect to the geometric gravity center of the coupled electrode element 110. The coupled elements 218 and 211 are line-symmetrical to each other with respect to an axis which passes the geometric gravity center of the coupled electrode element 110. The coupler shown in FIG. 6 can be regarded as a collection of six unit couplers.

FIG. 7 illustrates a coupler formed by further addition of the two coupled elements 215 and 216 shown in FIG. 5 to the example shown in FIG. 6. The coupled element 214 shares a portion including one end with the coupled element 215. The coupled element 216 shares a portion including one end with the coupled element 217. The coupler shown in FIG. 7 can be regarded as a collection of eight unit couplers.

FIGS. 8-11 illustrate S11 parameters of the couplers shown in FIGS. 4-7, respectively. A path length from the short-circuit portion 130 to the other end of each of the coupled elements 211-218 is about 13 millimeters (mm). Each of the couplers is about 13 mm×13 mm in size, and is about 1 mm apart from the grounded plate 140. The coupler shown in FIG. 4 has a resonant frequency of about 5.9 GHz. The coupler shown in FIG. 5 has a resonant frequency of about 5.4 GHz. The coupler shown in FIG. 6 has a resonant frequency of about 4.8 GHz. The coupler shown in FIG. 7 has a resonant frequency of about 4.5 GHz.

As obviously shown in FIGS. 8-11, the more coupled elements the coupler has, the lower the resonant frequency of the coupler is. As a quarter wavelength corresponding to 5.9 GHz, i.e., the resonant frequency of the coupler shown in FIG. 4, is about 13 mm, which approximately equals the path length from the short-circuit portion 130 to the other end of each of the coupled elements 211-218. In spite of having the same path length as the coupler shown in FIG. 4, however, the couplers shown in FIGS. 5-7 have lower resonant frequencies. If attention is paid to some unit coupler, it is conceivable that the other coupled elements (including the coupled electrode element 110) and the grounded plate 140 work as a capacitor that causes the above phenomenon. That is, if attention is paid to a unit coupler formed by the coupled element 211, a portion of the coupled electrode element 110, the feeder portion 120 and the short-circuit portion 130 shown in FIG. 7, it is conceivable that another portion of the coupled electrode element 110, the coupled elements 212-218 and the grounded plate 140 work as a capacitor. An effect of this capacitor on the resonant frequency will be estimated below.

It can be estimated that, a capacitor corresponding to an L-shaped area (which covers about three quarters of the coupler shown in FIG. 7) formed by the coupled elements 213-218 and a portion of the coupled electrode element 110 is added to the coupler shown in FIG. 4, so that the coupler shown in FIG. 7 is formed. A capacitance value of the capacitor corresponding to the L-shaped area is given as follows.

$$\begin{matrix}C = {ɛ}_{0} \frac{S}{d} \\ = 8.85 \times {10}^{- 12} \times \frac{\{ {( 13 \times {10}^{- 3} )}^{2} \} \times 3 / 4}{1 \times {10}^{- 3}} \\ = 1 [ pF ]\end{matrix}$$

The coupler shown in FIG. 4 provided with a capacitor of about 1 pF in parallel shows a resonant frequency of about 4.4. GHz. This resonant frequency is equivalent to the resonant frequency of the coupler shown in FIG. 7. As described above, the more coupled elements the coupler of the first embodiment has, the lower the resonant frequency (i.e., the band of use) of the coupler can be. Meanwhile, the more coupled elements the coupler has, the larger in size the coupler is likely to be. Thus, it is preferable to properly choose the number of the coupled elements in accordance with the size and the band of use that the coupler is required.

It is necessary to put paired couplers for transmission and reception close to each other for the close-proximity wireless communication by using the coupler 100, etc. An ordinary user manually positions one or both of the couplers. Thus, the paired couplers for transmission and reception are not necessarily coupled with each other in an optimized relative position. The one coupler can possibly be put in a rotated or offset (being off to one side from a center) state with respect to the other coupler. Thus, the couplers for the close-proximity wireless communication are required to be steadily and strongly coupled with each other even in a rotated or offset state. Performance of the coupler 100 in a rotated state will be mainly examined below.

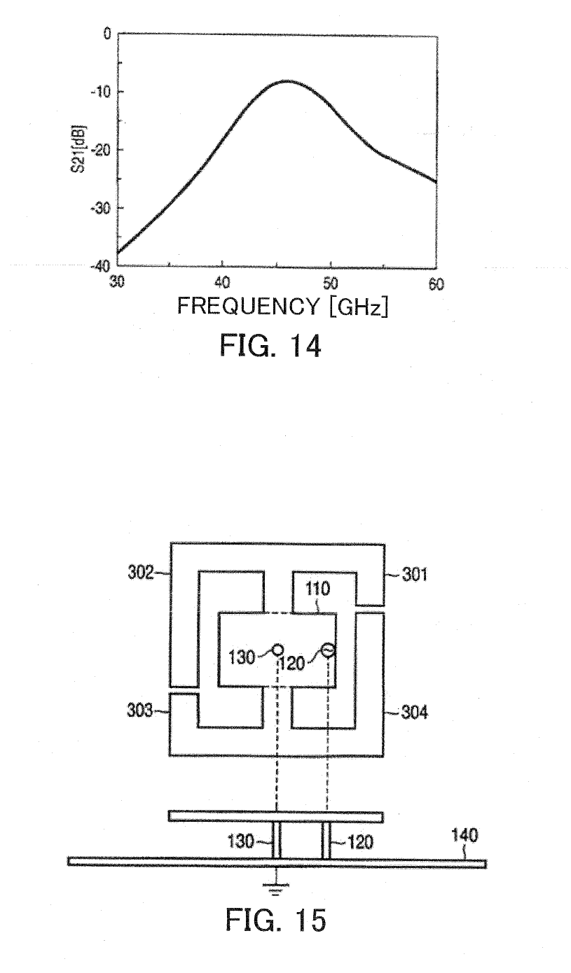

FIG. 12 conceptually illustrates a current distribution on the coupler 100 being resonant. Widths and directions of arrows shown in FIG. 12 represent amplitudes and directions of currents, respectively. On the coupler of the first embodiment, currents are concentrated to the short-circuit portion 130 (to form currents of large amplitudes). As being distributed apart from the short-circuit portion 130, the amplitudes of the currents decrease. That is, the coupler of the first embodiment has a radial current distribution. As the first embodiment is provided with the short-circuit portion 130 near the geometric gravity center of the coupled electrode element 110, the currents are concentrated near the geometric gravity center. Thus, as shown in FIG. 13, even if the one of the paired couplers is rotated with respect to the other, quality of communication is hardly degraded. In cases where the one coupler 100 is rotated by 0 (no rotation), 90, 180 and 270 degrees, S21 parameters being substantially equal as shown in FIG. 14 are obtained. For the simulation shown in FIG. 14, the paired couplers 100 are 10 mm apart from each other, the coupler 100 is 10 mm×10 mm in external size and 1 mm in thickness, and the grounded plate 140 is 30 mm×30 mm in external size.

As described above, the coupler 100 enables a radial current distribution by being provided with the short-circuit portion 130 at the geometric gravity center of the coupled electrode element 110. Thus, the paired couplers 100 can be steadily and strongly coupled with each other even in a rotated state.

The coupler of the first embodiment is not limited to the examples shown in FIGS. 1, 4, and 5-7. Modifications of the coupler of the first embodiment will be explained with reference to FIGS. 15-22.

The coupler 100 shown in FIG. 1 has symmetrical relations among the coupled elements 111-114. The coupler of the first embodiment, however, does not need the symmetrical relations. A coupler shown in FIG. 15 corresponds to a configuration in which the coupled elements 111-114 of the coupler 100 are replaced by coupled elements 301-304. As path lengths from the short-circuit portion 130 to tips of the respective coupled elements 301-304 are uneven, the coupler shown in FIG. 15 has a plurality of resonant frequencies. Thus, the coupler shown in FIG. 15 is broadband-matched.

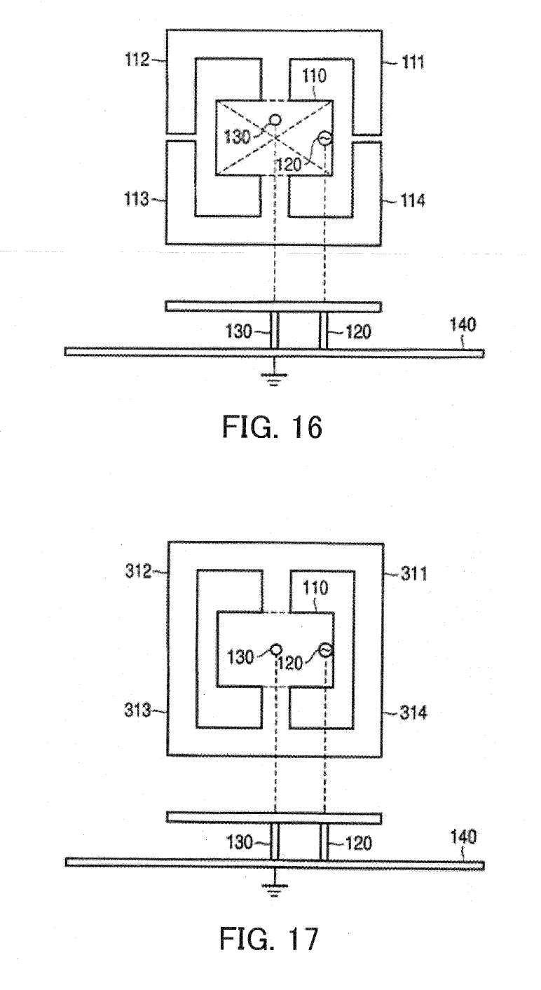

The coupler 100 shown in FIG. 1 has symmetrical relations among the coupled elements 111-114, and is provided with the short-circuit portion 130 near the geometric gravity center of the coupled electrode element 110. The path lengths from the short-circuit portion 130 to the tips of the respective coupled elements 111-114 are thereby substantially equal. The coupler shown in FIG. 16 is provided with the short-circuit portion 130 out of the geometric gravity center of the coupled electrode element 110. The short circuit portion 130, however, still remains near the geometric gravity center of the coupled electrode element 110 in FIG. 16. As path lengths from the short-circuit portion 130 to the tips of the respective coupled elements 111-114 of the coupler shown in FIG. 16 are uneven, the coupler shown in FIG. 16 has a plurality of resonant frequencies. Thus, the coupler shown in FIG. 16 is broadband-matched.

A coupler shown in FIG. 17 corresponds to a configuration in which the coupled elements 111-114 of the coupler 100 are replaced by coupled elements 311-314. The coupled elements 311 and 314 correspond to a configuration in which the tips of the coupled elements 111 and 114 are electrically connected to each other. The coupled elements 312 and 313 correspond to a configuration in which the tips of the coupled elements 112 and 113 are electrically connected to each other. The coupler shown in FIG. 17 includes, in comparison with the coupler 100, additional capacitive couplings formed by the connection between the coupled elements 311 and 314 and the connection between the coupled elements 312 and 313. Thus, the coupler shown in FIG. 17 has a lower resonant frequency than that of the coupler 100. That is, the coupler shown in FIG. 17 can be made equivalently smaller in external size so as to have the same resonant frequency as the coupler 100.

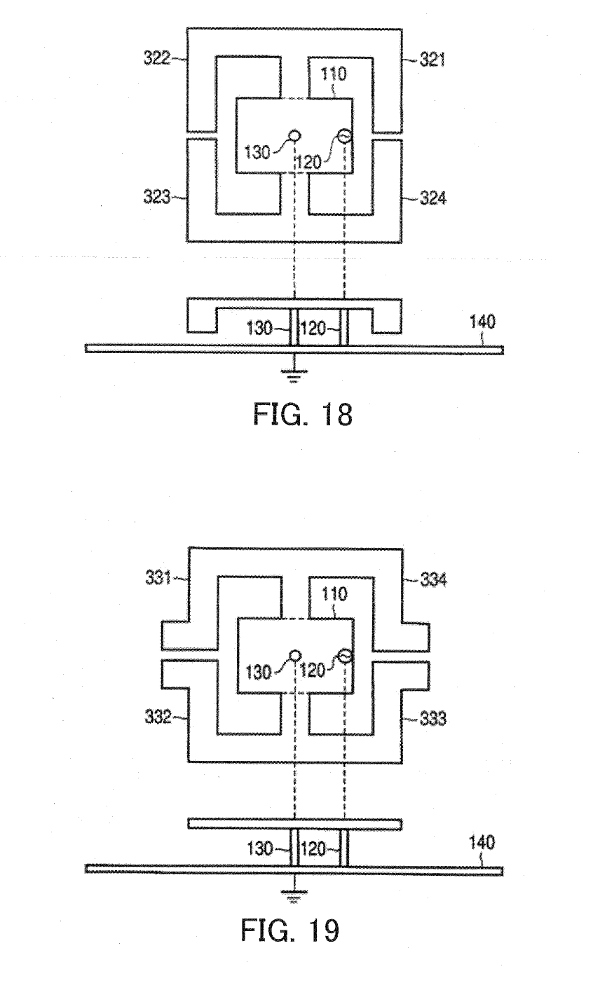

A coupler shown in FIG. 18 corresponds to a configuration in which the coupled elements 111-114 of the coupler 100 are replaced by coupled elements 321-324. The coupled elements 321-324 are bent in such a way that their tips are directed to the grounded plate 140. Upon being bent toward the grounded plate 140, the coupled elements come closer to the grounded plate 140 so that a capacitive coupling increases. Thus the coupler shown in FIG. 18 is useful for lowering the resonant frequency so as to make the coupler equivalently smaller in external size.

A coupler shown in FIG. 19 corresponds to a configuration in which the coupled elements 111-114 of the coupler 100 are replaced by coupled elements 331-334. The coupled elements 331-334 are shaped in such a way that their ends are wider in width. The greater areas of the coupled elements cause the capacitive couplings with the grounded plate 140 to increase. Thus, the coupler shown in FIG. 19 is useful for lowering the resonant frequency so as to make the coupler equivalently smaller in external size.

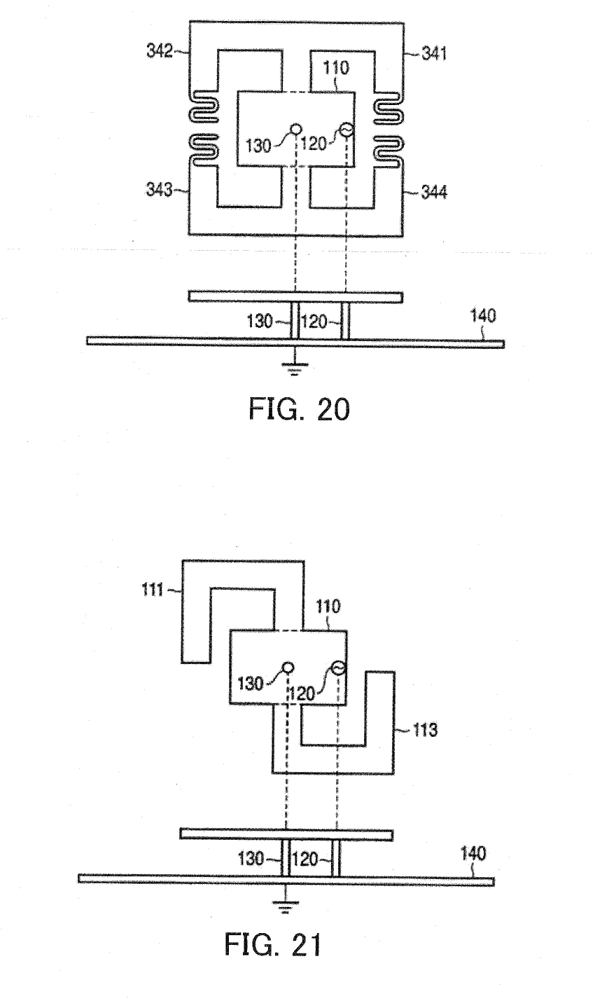

A coupler shown in FIG. 20 corresponds to a configuration in which the coupled elements 111-114 of the coupler 100 are replaced by coupled elements 341-344. The coupled elements 341-344 are meander-shaped at their ends. The meander-shaped coupled elements enables longer path lengths from the short-circuit portion 130 to the ends of the respective coupled elements than the linear-shaped coupled elements. Thus, the coupler shown in FIG. 20 is useful for lowering the resonant frequency so as to make the coupler equivalently smaller in external size.

A coupler shown in FIG. 21 corresponds to a configuration in which the coupled elements 112 and 114 of the coupler 100 are removed. Even if the coupled elements 112 and 114 are removed, the radial current distribution centered around the short-circuit portion 130 is substantially maintained. As some of the coupled elements are removed in comparison with the coupler 100, the coupler shown in FIG. 21 can be arranged in a smaller space.

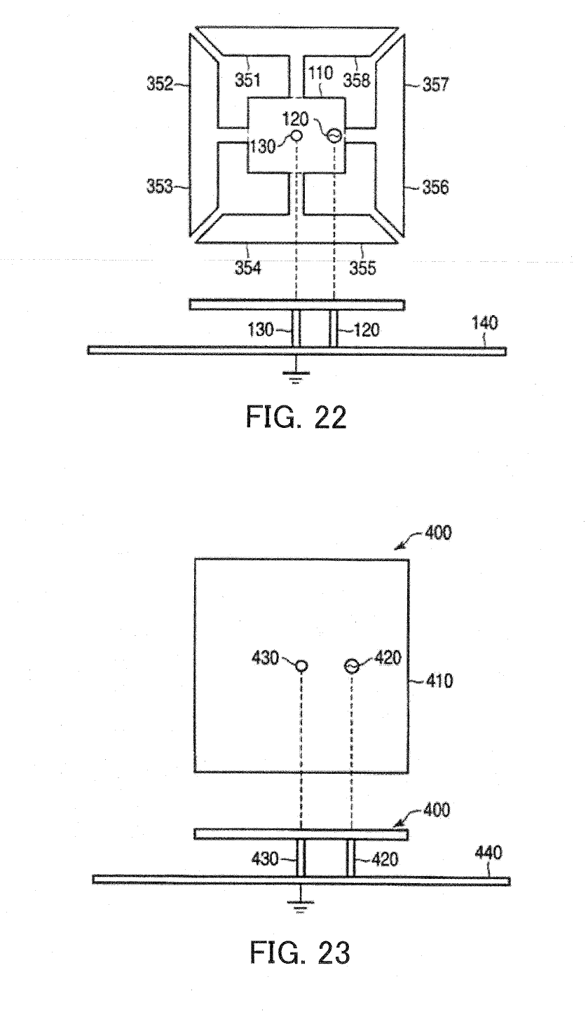

A coupler shown in FIG. 22 is formed in such a way that coupled elements 351-358 are electrically connected to the outer fringe of the coupled electrode element 110. The coupled elements 351-358 are formed, e.g., by the same conductive element as that of the coupled electrode element 110. The coupled element 351 shares a portion including one end with the coupled element 358, and the other ends of the coupled elements 351 and 358 are both open. The end portion shared by the coupled elements 351 and 358 is electrically connected to the outer fringe of the coupled electrode element 110. The coupled element 352 shares a portion including one end with the coupled element 353, and the other ends of the coupled elements 352 and 353 are both open. The end portion shared by the coupled elements 352 and 353 is electrically connected to the outer fringe of the coupled electrode element 110. The coupled element 354 shares a portion including one end with the coupled element 355, and the other ends of the coupled elements 354 and 355 are both open. The end portion shared by the coupled elements 354 and 355 is electrically connected to the outer fringe of the coupled electrode element 110. The coupled element 356 shares a portion including one end with the coupled element 357, and the other ends of the coupled elements 356 and 357 are both open. The end portion shared by the coupled elements 356 and 357 is electrically connected to the outer fringe of the coupled electrode element 110. As being provided with lots of coupled elements as shown in FIG. 22, the coupler of the first embodiment can make the path lengths from the short-circuit portion 130 to the ends of the respective couplers various, and can thereby be easily rendered broadband-matched. Further, as the coupler is provided with more coupled elements, the current distribution improves and a performance gap caused by the rotation can thereby be suppressed.

Incidentally, the elements which have been explained as to the above modifications can be properly combined as long as no conflict occurs. For the coupler shown in FIG. 21, e.g., the ends of the coupled elements 111 and 113 can be meander-shaped, made wide in width or bent toward the grounded plate 140.

As shown in FIG. 23, a coupler 400 of a second embodiment of the present invention has a coupled electrode element 410, a feeder portion 420, a short-circuit portion 430 and a grounded plate 440. Explanations of same or similar portions between the coupled electrode elements 410 and 110, the feeder portions 420 and 120, the short-circuit portions 430 and 130, and the grounded plate 440 and 140 are omitted below, and different portions will be mainly described.

The coupled electrode element 410 corresponds to an integration of the coupled electrode element 110 and the respective coupled elements (coupled elements 111-114, etc.). The coupled electrode element 410, e.g., can be understood to be formed by the respective coupled elements surrounding the outer fringe of the coupled electrode element 110 without leaving a space, and electrically connected to the outer fringe of the coupled electrode element 110. That is, the outer fringe of the coupled electrode element 110 can be understood to include the ends of the respective coupled elements described above. Thus, similarly as the first embodiment, a path length from the short-circuit portion 430 to the outer fringe of the coupled electrode element 410 which corresponds to the end of each of the coupled elements substantially equals a quarter wavelength of a carrier wave multiplied by an odd number. Further, as there are lots of other paths from the short-circuit portion 430 to the outer fringe of the coupled electrode element 410, the coupler 400 is broadband-matched.

Meanwhile, the coupled electrode element 410 can be understood as a single conductive element, rather than an integration of the coupled electrode element 110 and the respective coupled elements, as a matter of course. The coupled electrode element 410 is provided with the short-circuit portion 430 at a first point close to a geometric gravity center of the conductive element (coupled electrode element 410). The path length from the first point to a second point on the outer fringe of the conductive element substantially equals a quarter-wavelength of a carrier wave multiplied by an odd number.

As described above, the coupler of the second embodiment corresponds to an integration of the coupled electrode element 110 and the respective coupled elements described above. Thus, as being simpler in its shape than the coupler of the first embodiment, the coupler of the second embodiment can be easily processed and contributes to reducing the manufacturing cost. Further, as including various paths, the coupler of the second embodiment is broadband-matched.

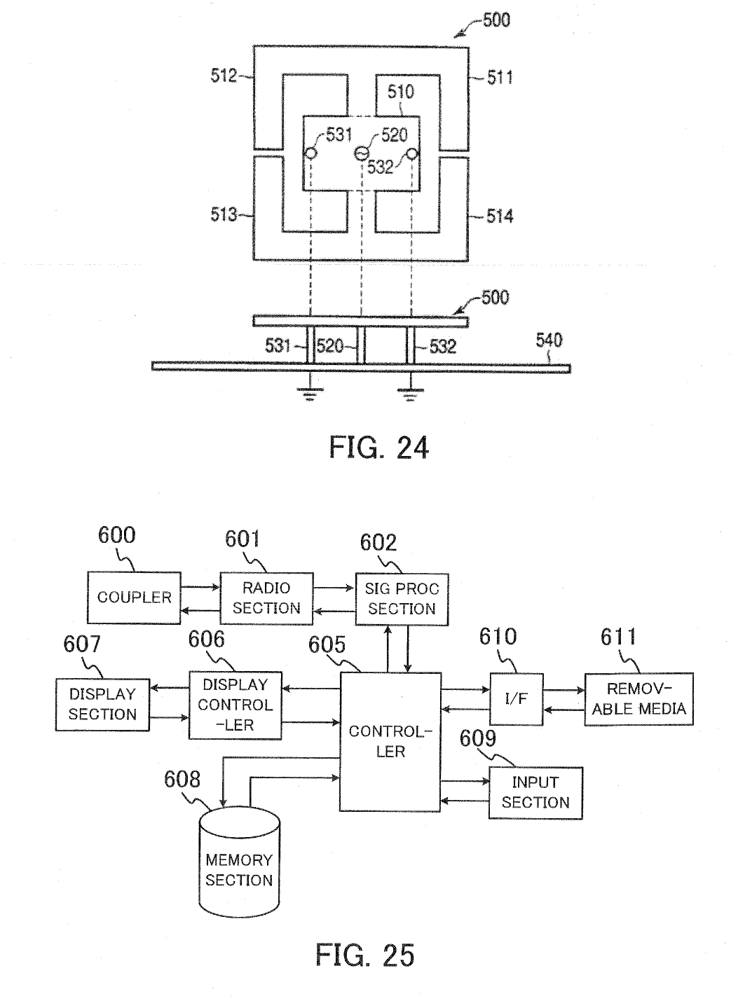

As shown in FIG. 24, a coupler 500 of a third embodiment of the present invention has a coupled electrode element 510, coupled elements 511-514, a feeder portion 520, short-circuit portions 531 and 532, and a grounded plate 540. Explanations of same or similar portions between the coupled electrode elements 510 and 110, the coupled elements 511-514 and 111-114, the feeder portions 520 and 120, the short-circuit portions 531, 532 and 130, and the grounded plate 540 and 140 are omitted below, and different portions will be mainly described.

The coupled electrode element 510 is provided near a geometric gravity center with the feeder portion 520. Assume, as explained below for simplicity, that the position of the feeder portion 520 agrees with the geometric gravity center of the coupled electrode element 510. The coupled electrode element 510 is provided a certain distance apart from the feeder portion 520 with the short-circuit portions 531 and 532 separately. The separations between the feeder portion 520 and the short-circuit portions 531 and 532 are determined from a viewpoint of impedance matching. The path lengths from the ends of the respective coupled elements 511-514 to at least one of the short-circuit portions 531 and 532 substantially equals a quarter-wavelength of the carrier wave multiplied by an odd number.

The two short-circuit portions 531 and 532 are provided, so that current sources increase to two. Incidentally, it is preferable from a viewpoint of symmetry of the current distribution that the feed portion 520 is provided at the midpoint between the short-circuit portions 531 and 532. Further, the coupled electrode element 510 can be provided with three or more short-circuit portions. As the number of the short-circuit portions increases, the current sources increase. In this case, it is preferable from the viewpoint of symmetry of the current distribution to make the separations between the respective short-circuit portions and the feeder portion 520 equal one another. In particular, it is preferable to arrange a plurality of the short-circuit portions on a circle centered around the position of the feeder portion 520 and having a radius of a certain distance at even intervals. Incidentally, the symmetry of the current distribution can be regarded not so important in order to arrange the plural short-circuit portions and the feeder portion 520. Even if the plural short-circuit portions and the feeder portion 520 are arranged off from such a distribution, an effect such that the current sources equivalently increase as the number of the short-circuit portions increases is maintained.

As described above, the coupler of the third embodiment is provided with a plurality of the short-circuit portions around the feeder portion arranged close to the geometric gravity center of the coupled electrode element, so that the current sources equivalently increase. The coupler of the third embodiment thereby renders a current amplitude great around the plural short-circuit portions, so that an area of a great current amplitude is broadened. That is, the communication quality can be prevented from being degraded when the coupler is offset.

The couplers of the above embodiments are usable for transmitting and receiving radio signals by using a wireless communication device (e.g., a mobile phone, a PC, etc.) shown in FIG. 25. The wireless communication device shown in FIG. 25 has a coupler 600, a radio section 601, a signal processing section 602, a controller 605, a display controller 606, a display section 607, a memory section 608, an input section 609, an I/F 610 and a removable medium 611.

The coupler 600 is constituted by one of the couplers of the above embodiments of the present invention. The coupler 600 is used for close-proximity wireless communication such as TransferJet. The radio section 601 works as instructed by the controller 605, up-converts a transmission signal provided by the signal processing section 602 into a radio frequency band and transmits the radio frequency signal through the coupler 600 to an opposite coupler, and receives a radio signal transmitted by the opposite coupler through the coupler 600 and down-converts the received signal into a baseband signal.

The signal processing section 602 modulates a carrier wave on the basis of the transmission data provided by the controller 605 so as to produce the transmission signal. The signal processing section 602 demodulates the baseband signal provided by the radio section 601 so as to obtain received data and provides the controller 605 with the received data. The controller 605 is provided with a processor such as a CPU, and exercises control over the respective components of the wireless communication device shown in FIG. 25.

The memory section 608 includes a recording medium such as a RAM (Random Access Memory), a ROM (Read Only Memory) or a hard disk, in which a control program and control data of the controller 605, various data made by a user, control data concerning the removable medium 611 and so on are stored. The display controller 606 drives and controls the display section 607 as directed by the controller 605, and displays an image signal based on display data provided by the controller 605 on the display section 607. The input section 609 includes a user interface which accepts a user's request by using an input device such as a plurality of key switches (e.g., so called ten keys (numeric keypad)) or a touch panel. The interface (I/F) 610 is an interface for physically and electrically connecting the removable medium 611 for data exchange, and is controlled by the controller 605.

The wireless communication device shown in FIG. 25 transmits content data, e.g., stored in the memory section 608 or the removable medium 611, to an opposite device by means of the close-proximity wireless communication means, stores content data received from the opposite device by means of the close-proximity wireless communication means in the memory section 608 or the removable medium 611, and displays the content data on the display section 607.

Incidentally, the present invention is not limited to the above respective embodiments as they are, and can be implemented at a practical stage by including modifications of the components within the scope of the present invention. Further, a plurality of the components disclosed for the above embodiments can be properly combined, so that various inventions can be formed. Further, e.g., a configuration for which some of the components of the respective embodiments are removed is conceivable. Moreover, the components included in the different embodiments can be properly combined with each other.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A coupler which is connectable to a feeder circuit of a wireless communication device, comprising:
a conductive element having a substantially plane face;
a short circuit portion provided to the conductive element, the short circuit portion being positioned closer to a geometric gravity center of the conductive element than to an outer fringe of the face of the conductive element;
a feeder portion provided to the conductive element, the feeder portion being positioned separately from the short circuit portion, the feeder portion electrically connecting the conductive element to the feeder circuit; and
a grounded plate short-circuited to the conductive element via the short circuit portion.

2. The coupler according to claim 1, further comprising a plurality of extra conductive elements,
each of the extra conductive elements having an end electrically connected to the outer fringe of the face of the conductive element.

3. The coupler according to claim 1, further comprising a plurality of extra conductive elements,
each of the extra conductive elements having an end electrically connected to the outer fringe of the face of the conductive element,
one of the extra conductive elements having another end from which a path length to the short circuit portion substantially equals a quarter wavelength of a carrier wave used by the wireless communication device multiplied by an odd number.

4. The coupler according to claim 1, wherein the short circuit portion is positioned at the geometric gravity center of the conductive element.

5. The coupler according to claim 1, further comprising a plurality of extra conductive elements,
each of the extra conductive elements having an end electrically connected to the outer fringe of the face of the conductive element,
two of the extra conductive elements being point-symmetrical with respect to the geometric gravity center of the conductive element.

6. The coupler according to claim 1, further comprising a plurality of extra conductive elements,
each of the extra conductive elements having an end electrically connected to the outer fringe of the face of the conductive element,
two of the extra conductive elements being line-symmetrical with respect to an axis which passes the geometric gravity center of the conductive element.

7. The coupler according to claim 1, further comprising a plurality of extra conductive elements,
the extra conductive elements being electrically connected to the outer fringe of the face of the conductive element, the extra conductive elements surrounding the outer fringe of the conductive element without leaving a space.

8. The coupler according to claim 1, wherein a path length from the short circuit portion to a point on the outer fringe of the face of the conductive element substantially equals a quarter wavelength of a carrier wave used by the wireless communication device multiplied by an odd number.

9. The coupler according to claim 1, wherein the grounded plate is substantially parallel to the face of the conductive element.

10. The coupler according to claim 1, wherein the grounded plate is larger than the face of the conductive element in size.

11. The coupler according to claim 1, further comprising a plurality of extra conductive elements,
each of the extra conductive elements having an end electrically connected to the outer fringe of the face of the conductive element,
one of the extra conductive elements having another end from which a path length to the feeder portion substantially equals a quarter wavelength of a carrier wave used by the wireless communication device multiplied by an odd number.

12. The coupler according to claim 1, wherein the separation between the short circuit portion and the feeder portion is smaller than one-tenth of a wavelength of a carrier wave used by the wireless communication device.

13. The coupler according to claim 1, further comprising a plurality of extra conductive elements,
each of the extra conductive elements having an end electrically connected to the outer fringe of the face of the conductive element,
one of the extra conductive elements is bent toward the grounded plate.

14. A coupler which is connectable to a feeder circuit of a wireless communication device, comprising:
a conductive element having a substantially plane face;
a feeder portion provided to the conductive element, the feeder portion being positioned closer to a geometric gravity center of the conductive element than to an outer fringe of the face of the conductive element, the feeder portion electrically connecting the conductive element to the feeder circuit;
a plurality of short circuit portions provided to the conductive element, the short circuit portions being positioned separately from the feeder portion; and
a grounded plate short-circuited to the conductive element via the short circuit portions.

15. A wireless communication device, comprising:
a radio circuit which outputs and receives an outgoing radio signal and an incoming radio signal, respectively;
a feeder circuit which transfers the outgoing radio signal and the incoming radio signal, and;
a coupler connected to the feeder circuit, the coupler including
a conductive element having a substantially plane face,
a short circuit portion provided on the conductive element, the short circuit portion being positioned closer to a geometric gravity center of the conductive element than to an outer fringe of the face of the conductive element,
a feeder portion provided on the conductive element, the feeder portion being positioned separately from the short circuit portion, the feeder portion electrically connecting the conductive element to the feeder circuit, and
a grounded plate electrically connected to the conductive element via the short circuit portion.
